(19) United States
(12) Patent Application Publication
(10) Pub. No.: US 2005/0252363 A1
(43) Pub. Date: Nov. 17, 2005

(54) Electric/acoustic guitar

(76) Inventor: Daniel P. Rockett, Marina Del Rey, CA (US)

Correspondence Address: HOLLAND & KNIGHT LLP, 633 WEST FIFTH STREET, TWENTY-FIRST FLOOR, LOS ANGELES, CA, 90071-2040, US

(21) Appl. No.: 10/842,818

(22) Filed: May 11, 2004

(51) Int. Cl. G10H 3/00; G10H 3/14

(52) U.S. Cl. 84/723

(57) ABSTRACT

A musical instrument for use with an acoustic amplifier and an electric guitar amplifier for selectively providing the amplified sounds of an acoustic guitar, an electric guitar or both concurrently and in desired synchronization. The instrument includes an acoustic pickup and an electric pickup. The acoustic pickup is mounted adjacent the bridge of the guitar and provides a first output signal to an acoustic amplifier. The electric pickup is mounted in an insert in the sound hole of the guitar and provides a second output signal to an electric guitar amplifier. A pair of foot operated controllers are electrically coupled to the pickups for individually varying the strength of the output signals. If desired, a third controller is electrically coupled to one of the pickups to vary the synchronization of the signals.

### BACKGROUND OF THE INVENTION

The present invention relates to guitars and, more particularly, to an electric/acoustic guitar capable of functioning as an electric guitar or as an acoustic guitar or of concurrently producing both the sounds of an electric guitar and an acoustic guitar in perfect synchronization.

Electric guitars and acoustic guitars and the music they produce are well known. Electric guitars are used with external speakers and amplifiers. When used in live performances in relatively large areas, the sound of an acoustic guitar also is amplified and many bands concurrently employ both acoustic and electric guitars for the different sounds they produce. It is difficult, however, for the players of the different instruments to perfectly synchronize their guitars. The present invention provides a single guitar which can be used either as an electric guitar or an acoustic guitar, with or without amplification, and is capable of simultaneously providing the sounds of both an electric and acoustic guitar in perfect or other desired synchronization. In addition, the present invention allows for the simple modification of an existing acoustic guitar to provide such features.

### SUMMARY OF THE INVENTION

Briefly, the present invention comprises a modified acoustic guitar having steel strings and including an acoustic pickup and an output jack for communicating the pickup with an acoustic amplifier or public address system. An electric pickup is mounted in an insert, preferably formed of wood, that is secured in the guitar sound hole, sealing the hole. The electric pickup is in electrical communication with a second output jack for electrically coupling the electric pickup with an electric guitar amplifier. Foot operated volume controls are provided between the two pickups and their respective amplifiers to provide independent control of the strength of the signals from the pickups to their respective amplifiers. Through such a configuration, both the acoustic and electric pickups can be individually active or concurrently active so as to produce two separate tones in unison, whereby a single guitar can function solely as an electric guitar, solely as an acoustic guitar or as both concurrently and in perfect synchronization. An additional controller can be electrically coupled to one or both of the pickups to enable the player of the guitar to control the synchronization of the two signals for a more personalized sound.

### BRIEF DESCRIPTION OF THE DRAWINGS

FIG. 1 is a perspective view of the electric/acoustic guitar of the present invention.

FIG. 2 is a side view of the guitar of the present invention with a portion of the side wall removed to illustrate the interior components thereof.

FIG. 3 is a partially exploded view of the guitar of the present invention.

FIG. 4 is an enlarged sectional view showing the insert and electrical pickup of the present invention.

FIG. 5 is an enlarged top view of the insert and electrical pickup of the present invention.

FIG. 6 is a schematic representation of the present invention, showing the electrical connections between the guitar and the acoustic and electric guitar amplifiers.

### DETAILED DESCRIPTION OF THE PREFERRED EMBODIMENT

Referring now in detail to the drawings, the musical instrument 10 of the present invention is comprised of a conventional acoustic guitar 12, preferably constructed of wood, and provided with steel strings 13, an acoustic pickup 14 disposed on the guitar bridge 16 under the bridge bone 18, a 0.25 in. cable connector outlet jack 20 mounted in the tail 22 of the guitar body 24 and a conventional equalization control 26 mounted on the exterior side wall 28 of the guitar. Control 26 is in electrical communication with the acoustic pickup 14 via electrical line or wire 30 and the pickup is in electrical communication with the outlet jack 20 via electrical line or wire 32. The acoustic pickup 14 is then selectively connected with an acoustic combo amplifier/speaker 34 or a public address system (not shown) to amplify the acoustic sounds and tones of the guitar as will be discussed. Hereinafter the term acoustic amplifier/speaker will be used to include both an acoustic amplifier/speaker combination and a public address system.

While any acoustic guitar of acceptable quality can be employed in the present invention, a Taylor® 714 Concert Edition acoustic guitar which is equipped with a Fishman® acoustic pickup and an associated cable connector outlet jack, has been successfully employed in the present invention. That guitar also includes a volume control in addition to the equalization control which, as will be apparent, is redundant in the preferred embodiment of the present invention. If the musical instrument or modified guitar 10 were constructed using a basic acoustic guitar without at least an acoustic pickup and associated electric cable outlet jack (or equivalent), those items would have to be added to the guitar to form the present invention.

The guitar 10 of the present invention also includes an electric pickup 36 that is in electrical communication with a second 0.25 in. cable connector outlet jack 38 mounted in the guitar tail 22. Pickup 36 is carried by an insert 40, preferably formed of wood and sized so as to seal the sound hole 42 of the guitar to prevent electrical feedback. In the preferred embodiment of the invention, a dual coil Barkus Berry Humbucker pickup is utilized for the electrical pickup 36.

An acoustic pickup is somewhat similar to an electric pickup but acts more like a microphone. An electric pickup is a device which, through the interaction of a steel string and a magnetic coil, translates a sound vibration into an electric current. Essentially, this is accomplished by an induction element (electromagnetic coils) in the pickup, creating an alternating electrical current that runs through a circuit in line creating a signal whose defining characteristics (wavelength, frequency, etc.) are then translated back into sound waves with the electromagnet in an electric guitar amplifier's speaker. The same is generally true of an acoustic pickup. However, in the case of an acoustic pickup, air displacement vibrates a metallic plate which in turn, translates its vibration into an electric current. In other words, where an electric guitar is solely dependent upon the interaction of the steel strings and the magnetic coil of the pickup within that magnetic field, an acoustic pickup takes air movement from the strings of an acoustic guitar (or any other input such as hitting the body of the guitar with hands) and resonates a strip of metal within the bridge of the guitar, and uses that input as the vibration that sets off the magnetic reaction in the acoustic pickup. The metal plate is doing the same job in the acoustic guitar as the steel strings of the electric guitar, it just adds all of the ambient vibrations within the body of the guitar, to the defining characteristics of the acoustic signal. Because, however, the electric pickup 36 is a magnetic pickup (dual coil to minimize interference hum), the guitar strings 13 must be of an electrically conductive material. Thus, the non-conductive strings on a conventional acoustic guitar 12 must be replaced with electrically conductive strings such as steel strings 13.

Pickup 36 communicates with cable connector jack 38 via electric line or wire 44 for selective connection of pickup 36 with a conventional electric guitar combo amplifier/speaker 46. In one embodiment of the invention, the insert 40 is formed of rosewood, both for its aesthetic appearance and its acoustic qualities. Other woods that are not too dense and indeed other materials may also be suitable for insert 40. Insert 40 defines a body portion 48 of about 4″ in diameter and 2.5″ deep and a radially projecting lip portion 50. A recessed area 52 is provided in the upper end portion of the insert to receive the electric pickup 36. It should be noted that the seal formed about the sound hole 42 need not be air tight. Indeed, a small channel 54 is provided in the body of the insert to enable wire 44 to extend therethrough and electrically couple pickup 36 with the outlet jack 38. It has not been found necessary to seal channel 54 about wire 44 to prevent feedback.

To secure the insert 40 in place on guitar 10, two rectangular support members 56, preferably formed of wood, are glued or otherwise attached to the interior of the guitar so as to overlap the sound hole 42. The insert 40 is then secured in place by wood screws 58 projecting through the insert lip portion 50 and into the support members 56. It is to be understood that other attachment means and other insert configurations could be employed to seal the sound hole and carry the electric pickup 36.

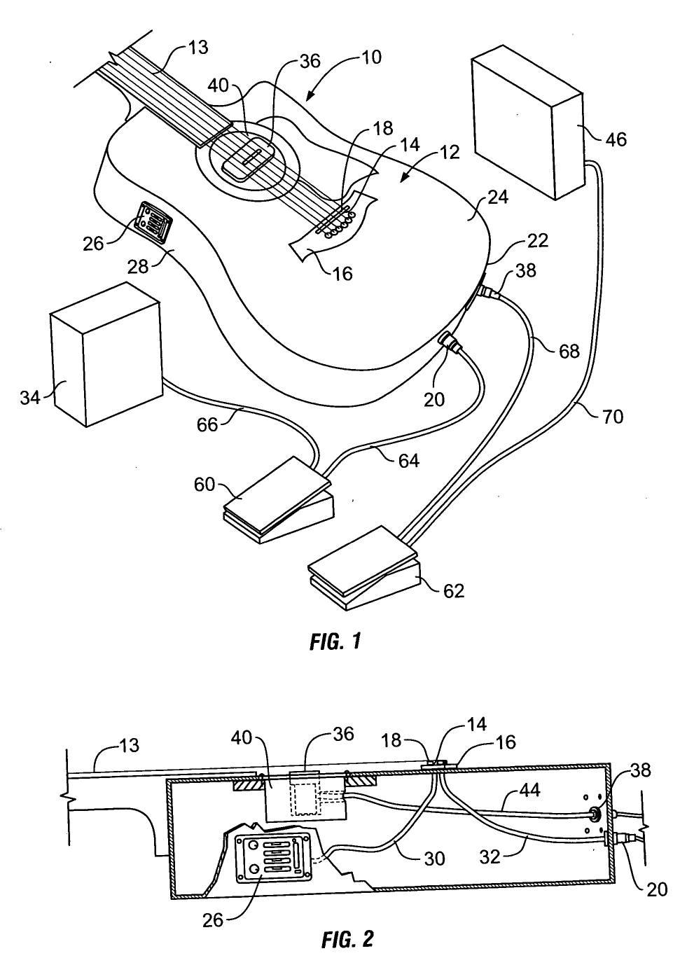

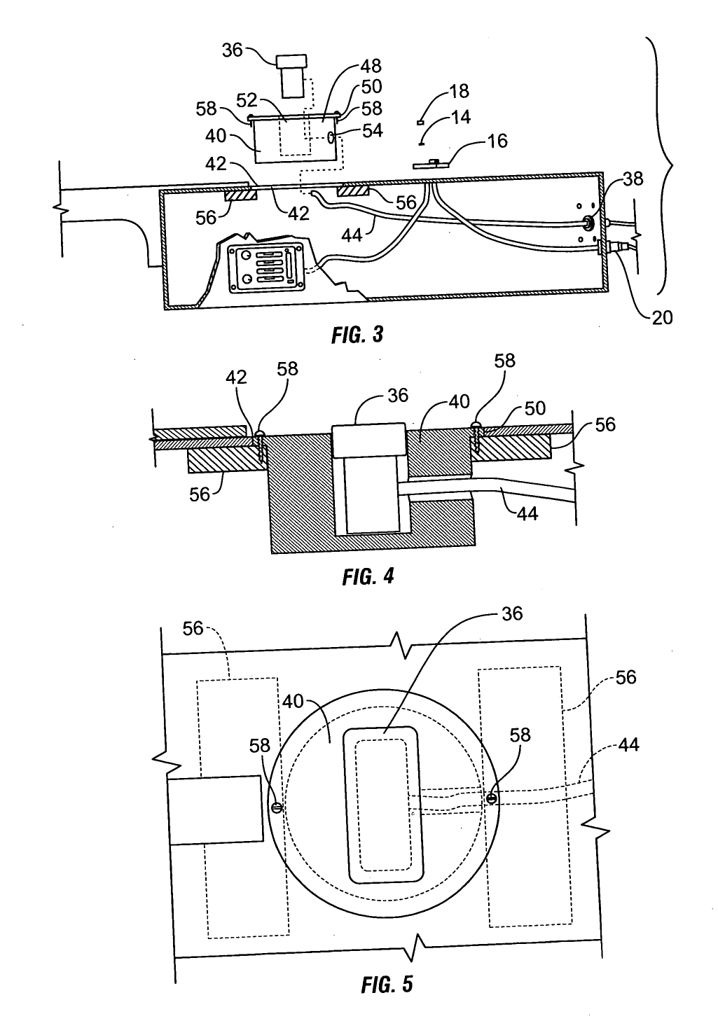

As illustrated in FIG. 1, pedal-operated volume controls 60 and 62 are disposed between the acoustic outlet jack 20 and the acoustic amplifier 34 and between the electric outlet jack 38 and the electric guitar amplifier 46 via electrical lines 64 and 66 and 68 and 70 to enable the user to individually control the strength of the signals passing from the respective pickup to the associated amplifier/speaker without having to interrupt the playing of the guitar. In the preferred embodiment of the invention, Ernie Ball® volume control pedals marketed by Ernie Ball, Inc. of San Luis Obispo, Calif. are employed as controllers 60 and 62.

As a result of the aforesaid configuration, the acoustic and electric pickups 14 and 36 can be selectively activated and the signals generated thereby individually controlled. Thus, the electric/acoustic guitar 10 of the present invention can function as an electric guitar, an acoustic guitar or concurrently provide the musical sounds of both an acoustic guitar and an electrical guitar in perfect synchronization.

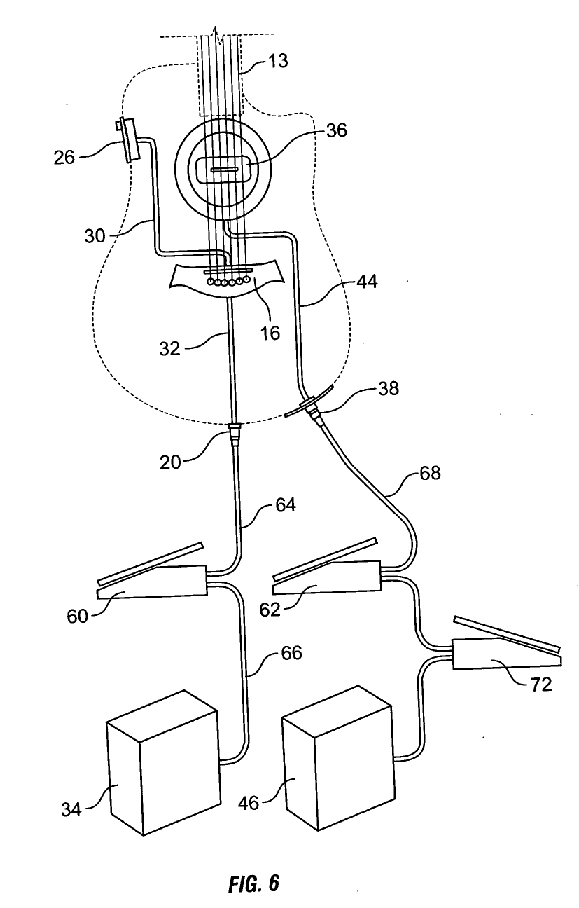

A third controller 72 can also be employed to vary the synchronization between the two signals and thus between the amplified acoustic and the electric guitar music emanating from the associated speakers. Controller 72 is preferably electrically coupled to the electric pickup 36 to affect the desired lag of the electrical guitar music behind the acoustical guitar music (see FIG. 6). A Line 6 DL4 Delay Modeler Pedal has been successfully employed as controller 72 in the current invention. Alternatively, controller 72 could be coupled with the acoustic pickup 14 to effect a desired delay of the acoustic guitar music. Or, a controller or pair of controllers could be coupled with both pickups to provide total synchronization control over the two output signals.

While the present invention has been described in terms of a modified acoustic guitar, the musical instrument or guitar 10 of the present invention could be formed without a sound hole, obviating the need to seal the hole to prevent feedback. In the construction of the guitar, the electrical pickup 36 would be located on the body of the guitar below the strings where the sound hole would otherwise be located. Otherwise, the guitar would preferably be constructed of wood and have the same configuration as the acoustic guitar described above.

It should also be noted that the elements comprising guitar 10 allow a conventional acoustic guitar to be readily modified to produce the musical instrument or electric/acoustic guitar 10. In this regard, it should be noted that electric guitar pickups are magnetic and thus the strings of electric guitars must be steel-wound as opposed to the brass-wound strings of acoustic guitars. While some might argue that this would detract from the acoustical tone of guitar 10, this has not proved to be the case.

Various changes and modifications may be made in carrying out the present invention without departing from the spirit and scope thereof. Insofar as these changes and modifications are within the purview of the appended claims, they are to be considered a part of the present invention.

1. A musical instrument for use with an acoustic amplifier and an electric guitar amplifier, said instrument comprising: an acoustic guitar of the type having a sound hole therein and an acoustic pickup mounted thereon for providing a first output signal to an acoustic amplifier; an insert member disposed within the sound hole of said guitar; an electric pickup carried by said insert for providing a second output signal to an electric guitar amplifier; a first controller electrically coupled to said acoustic pickup for varying the strength of said first output signal; and a second controller electrically coupled to said electric pickup for varying the strength of said second output signal whereby said instrument can function as an electric guitar, an acoustic guitar or concurrently providing the musical sounds of both an acoustic guitar and an electric guitar in substantial synchronization.

2. The musical instrument of claim 1 wherein said insert is secured to said guitar so as to seal said sound hole to prevent feedback.

3. The musical instrument of claim 1 wherein said insert is formed of wood and is sized and configured so as to seal said sound hole to prevent feedback and including fastening members for securing said insert to said guitar.

4. The musical instrument of clam 1 including first and second electric cable outlet jacks carried by said guitar, said first outlet jack being in electric communication with said acoustic pickup for electrically coupling said acoustic pickup to the acoustic amplifier and second outlet jack being in electric communication with said electric pickup for electrically coupling said electric pickup to the electric guitar amplifier.

5. The musical instrument of claim 1 wherein said first and second controllers each comprise pedal portions capable of being independently operated by the feet of a player of said musical instrument whereby operation of said controllers will not interfere with the playing of the instrument.

6. The musical instrument of claim 1 including a third controller electrically coupled to one of said pickups for selectively varying the synchronization of said first and second signals.

7. The musical instrument of claim 2 including first and second electric cable outlet jacks carried by said guitar, said first outlet jack being in electric communication with said acoustic pickup for electrically coupling said acoustic pickup to the acoustic amplifier and second outlet jack being in electric communication with said electric pickup for electrically coupling said electric pickup to the electric guitar amplifier.

8. The musical instrument of claim 2 wherein said first and second controllers each comprise pedal portions capable of being independently operated by the feet of a player of said musical instrument whereby operation of said controllers will not interfere with the playing of the instrument.

9. The musical instrument of claim 3 wherein said insert is formed of rosewood.

10. The musical instrument of claim 7 wherein said first and second controllers each comprise pedal portions capable of being independently operated by the feet of a player of said musical instrument whereby operation of said controllers will not interfere with the playing of the instrument.

11. The musical instrument of claim 8 including a third controller electrically coupled to one of said pickups for selectively varying the synchronization of said first and second signals.

12. The musical instrument of claim 10 wherein said insert is formed of wood.

13. A musical instrument for use with an acoustic amplifier and an electric guitar amplifier, said instrument comprising: an acoustic guitar of the type having a sound hole therein and an acoustic pickup mounted thereon for providing a first output signal to an acoustic amplifier; an insert member disposed within said sound hole so as to seal said sound hole to prevent feedback; an electric pickup carried by said insert for providing a second output signal to an electric guitar amplifier; a first controller electrically coupled to said acoustic pickup for varying the strength of said first output signal; a second controller electrically coupled to said electric pickup for varying the strength of said second output signal and a third controller electrically coupled to one of said pickups for varying the synchronization of said first and second signals whereby said instrument can function as an electric guitar, an acoustic guitar or concurrently providing the musical sounds of both an acoustic guitar and an electric guitar in selective synchronization.

14. The musical instrument of clam 13 including first and second electric cable outlet jacks carried by said guitar, said first outlet jack being in electric communication with said acoustic pickup for electrically coupling said acoustic pickup to the acoustic amplifier and second outlet jack being in electric communication with said electric pickup for electrically coupling said electric pickup to the electric guitar amplifier.

15. The musical instrument of claim 13 wherein said first and second controllers each comprise pedal portions capable of being independently operated by the feet of a player of said musical instrument whereby operation of said controllers will not interfere with the playing of the instrument.

16. The musical instrument of claim 13 wherein said insert is formed of wood.

17. The musical instrument of claim 14 wherein said first and second controllers each comprise pedal portions capable of being independently operated by the feet of a player of said musical instrument whereby operation of said controllers will not interfere with the playing of the instrument.

18. A musical instrument for use with an acoustic amplifier and an electric guitar amplifier, said instrument comprising: an acoustic guitar of the type having a sound hole therein, an acoustic pickup mounted thereon for providing a first output signal and a first outlet jack carried by the acoustic guitar in electric communication with said pickup for directing said first output signal to an acoustic amplifier; an insert member disposed within said sound hole so as to seal said sound hole to prevent feedback; an electric pickup carried by said insert for providing a second output signal; a second outlet jack carried by said guitar in electric communication with said electric pickup for directing said second output signal to an electric guitar amplifier; a first controller electrically coupled to said acoustic pickup for varying the strength of said first output signal; and a second controller electrically coupled to said electric pickup for varying the strength of said second output signal whereby said instrument can function as an electric guitar, an acoustic guitar or concurrently providing the musical sounds of both an acoustic guitar and an electric guitar in substantial synchronization.

19. The musical instrument of claim 18 wherein said insert if formed of wood.

20. The musical instrument of claim 18 wherein said insert if formed of rosewood.

21. The musical instrument of claim 18 wherein said first and second controllers each comprise pedal portions capable of being independently operated by the feet of a player of said musical instrument whereby operation of said controllers will not interfere with the playing of the instrument.

22. The musical instrument of claim 18 including a third controller electrically coupled to one of said pickups for selectively varying the synchronization of said first and second signals.

23. The instrument of claim 20 wherein said insert if formed of wood.

24. The musical instrument of claim 21 including a third controller electrically coupled to one of said pickups for selectively varying the synchronization of said first and second signals.

25. A musical instrument for use with an acoustic amplifier and an electric guitar amplifier, said instrument comprising: a guitar having a body portion, a neck portion, a bridge and a plurality of strings extending axially thereon; an acoustic pickup mounted on said guitar adjacent said bridge for providing a first output signal to an acoustic amplifier; an electric pickup for providing a second output signal to an electric guitar amplifier, said electric pickup being disposed on said body portion of said guitar in axial alignment with said acoustic pickup and spaced from said acoustic pickup toward said neck portion of said guitar; a first controller electrically coupled to said acoustic pickup for varying the strength of said first output signal; and a second controller electrically coupled to said electric pickup for varying the strength of said second output signal whereby said instrument can function as an electric guitar, an acoustic guitar or concurrently providing the musical sounds of both an acoustic guitar and an electric guitar in substantial synchronization.

26. The musical instrument of clam 25 including first and second electric cable outlet jacks carried by said musical instrument, said first outlet jack being in electric communication with said acoustic pickup for electrically coupling said acoustic pickup to the acoustic amplifier and second outlet jack being in electric communication with said electric pickup for electrically coupling said electric pickup to the electric guitar amplifier.

27. A musical instrument for use with an acoustic amplifier and an electric guitar amplifier, said instrument comprising: a guitar having a body portion, a neck portion, a bridge and a plurality of strings extending axially thereon; an acoustic pickup mounted on said guitar adjacent said bridge for providing a first output signal; a first outlet jack carried by said guitar in electric communication with said acoustic pickup for directing said first output signal to an acoustic amplifier; an electric pickup for providing a second output signal, said electric pickup being disposed on said body portion of said guitar in axial alignment with said acoustic pickup and spaced from said acoustic pickup toward said neck portion of said guitar; a second outlet jack carried by said guitar in electrical communication with said electric pickup for directing said second output signal to an electric guitar amplifier; a first controller electrically coupled to said acoustic pickup for varying the strength of said first output signal; and a second controller electrically coupled to said electric pickup for varying the strength of said second output signal whereby said instrument can function as an electric guitar, an acoustic guitar or concurrently providing the musical sounds of both an acoustic guitar and an electric guitar in substantial synchronization.

28. The musical instrument of claim 27 wherein said first and second controllers each comprise pedal portions capable of being independently operated by the feet of a player of said musical instrument whereby operation of said controllers will not interfere with the playing of the instrument.

29. The musical instrument of claim 27 including a third controller electrically coupled to one of said pickups for selectively varying the synchronization of said first and second signals.

30. The musical instrument of claim 28 including a third controller electrically coupled to one of said pickups for selectively varying the synchronization of said first and second signals.

31. An assembly for use with an acoustic guitar of the type having a body portion, a neck portion, a bridge, a sound hole in said body portion and a plurality of strings extending axially thereon, an acoustic amplifier and an electric guitar amplifier, said assembly comprising: an acoustic pickup adapted to be mounted adjacent the bridge of the guitar for providing a first output signal to an acoustic amplifier; an insert sized and configured to fit within and seal said sound hole so as to prevent feedback; a plurality of fastening members for securing said insert within said sound hole; an electric pickup carried by said insert for providing a second output signal to an electric guitar amplifier; and a controller adapted to be electrically coupled to said electric pickup for varying the strength of said second output signal whereby the acoustic guitar can function as an electric guitar, an acoustic guitar or concurrently providing the musical sounds of both an acoustic guitar and an electric guitar in substantial synchronization.

32. The instrument of claim 31 wherein said insert is formed of wood.

33. The assembly of claim 31 wherein said controller comprises a pedal portion capable of being operated by the foot of a player of the guitar whereby operation of the controller will not interfere with the playing of the guitar.

34. The assembly of claim 31 including a second controller adapted to be electrically coupled to said acoustic pickup for varying the strength of said first output.

35. The assembly of claim 31 including a third controller electrically coupled to said electric pickup for varying the synchronization of said first and second signals.

36. The assembly of claim 35 wherein said first, second and third controllers comprise pedal portions capable of being operated by the foot of a player of the guitar whereby operation of the controller will not interfere with the playing of the guitar.

37. The assembly of claim 36 wherein both said first and second controllers are independently operable.

38. An assembly for use with an acoustic guitar of the type having a sound hole therein, an acoustic pickup mounted thereon for providing a first output signal and an electric cable outlet jack carried by the acoustic guitar in electric communication with said pickup for directing said first output signal to an acoustic amplifier, said assembly comprising: an insert sized and configured to fit within and seal said sound hole so as to prevent feedback; a plurality of fastening members for securing said insert within said sound hole; an electric pickup carried by said insert for providing a second output signal; a second outlet jack adapted for electric communication with said electric pickup for directing said second output signal to an electric guitar amplifier; and a controller adapted to be electrically coupled to said electric pickup for varying the strength of said second output signal whereby the acoustic guitar can function as an electric guitar, an acoustic guitar or concurrently providing the musical sounds of both an acoustic guitar and an electric guitar in substantial synchronization.

39. The instrument of claim 38 wherein said insert is formed of wood.

40. The assembly of claim 38 wherein said controller comprises a pedal portion capable of being operated by the foot of a player of the guitar whereby operation of the controller will not interfere with the playing of the guitar.

41. The assembly of claim 38 including a second controller adapted to be electrically coupled to said acoustic pickup for varying the strength of said first output.

42. The assembly of claim 38 including a third controller electrically coupled to said electric pickup for varying the synchronization of said first and second signals.

43. The assembly of claim 42 wherein said first, second and third controllers comprise pedal portions capable of being operated by the foot of a player of the guitar whereby operation of the controller will not interfere with the playing of the guitar.

44. The assembly of claim 43 wherein both said first and second controllers are independently operable.
